(19) United States
(12) Patent Application Publication
(10) Pub. No.: US 2026/0268706 A1
(43) Pub. Date: Sep. 10, 2026

(54) Image-Space UV Map-Based Tracking of Image Regions in Video

(71) Applicant: Disney Enterprises, Inc., Burbank, CA (US)

(72) Inventors: Gaspard Zoss, Zurich (CH); Derek Edward Bradley, Zurich (CH)

(21) Appl. No.: 19/074,998

(22) Filed: Mar. 10, 2025

(51) Int. Cl. G06V 40/16; G06T 13/40; G06T 15/20; G06T 15/40; G06T 19/00; G06V 10/26; G06V 10/54; G06V 10/77

(52) U.S. Cl. CPC G06V 40/171; G06T 13/40; G06T 15/205; G06T 15/40; G06T 19/00; G06V 10/267; G06V 10/54; G06V 10/7715

(57) ABSTRACT

A system includes a hardware processor and a memory storing software code. The hardware processor executes the software code to receive a sequence of images each including a depiction of the same object, and for each image of the sequence of images: extract visual features of the object depicted in the image and process the visual features to predict an image-space UV map of the object. The hardware processor further executes the software code to receive a masking input identifying a portion of the object to be overlaid by a mask, and mask, using the masking input and the image-space UV map predicted for each image, a respective portion of each image of the sequence of images corresponding to the identified portion to produce a masked sequence of images.

### BACKGROUND

The processing performed in visual effects pipelines typically includes isolating and tracking specific parts of a video in order to achieve color correction, painting, masking or even extraction of individual elements. Often referred to as rotoscoping, these actions are often used to isolate part of a face such as eye bags, the lips, and the like, in order to apply localized effects. These localized effects can include digital make up, skin smoothing, de-aging, and/or the addition or removal of features such as scars or pimples, for example.

In the conventional art, rotoscoping is often performed on a frame-by-frame basis and typically requires many hours of manual labor to produce a good result. Although existing techniques such as optical flow allow propagating the isolated areas to neighboring frames of video, the effects of occlusions and drift limit the benefits of those existing techniques and often continue to require significant manual work to correct. Consequently, there is a need in the art for an automated technique for mapping rotoscoping effects across video frames included in a video sequence.

### BRIEF DESCRIPTION OF THE DRAWINGS

FIG. 1 shows an exemplary system for performing image-space UV map-based tracking of image regions in video, according to one implementation;

FIG. 2 shows a conceptual diagram depicting a process for performing image-space UV map-based tracking of image regions in video, according to one implementation;

FIG. 3 shows an exemplary processing pipeline for predicting an image-space UV map, according to one implementation; and

FIG. 4 shows a flowchart presenting an exemplary method for performing image-space UV map-based tracking of image regions in video, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As stated above, the processing performed in visual effects pipelines typically includes isolating and tracking specific parts of a video in order to achieve color correction, painting, masking or even extraction of individual elements. Often referred to as rotoscoping, these actions are often used to isolate part of a face such as eye bags, the lips, and the like, in order to apply localized effects. These localized effects can include digital make up, skin smoothing, de-aging, and/or the addition or removal of features such as scars or pimples, for example.

As also stated above, in the conventional art, rotoscoping is often performed on a frame-by-frame basis and typically requires many hours of manual labor to produce a good result. Although existing techniques such as optical flow allow propagating the isolated areas to neighboring frames of video, the effects of occlusions and drift limit the benefits of those existing techniques and often continue to require significant manual work to correct.

The present application discloses systems and methods for performing image-space UV map-based tracking of image regions in video that address and overcome the drawbacks and deficiencies in the conventional art. The present novel and inventive image-space UV map-based image region tracking solution uses the relationship between points on a three-dimensional (3-D) surface and their corresponding two-dimensional (2-D) UV locations. It is noted that in computer graphics, a 3-D mesh often has a corresponding 2-D texture space for defining properties like the surface color as an image. This texture space is usually referred to as a UV space, since points on the mesh have their traditional (x, y, z) position coordinates, plus two additional (u, v) texture coordinates for looking up the color in the texture image. The present image-space UV map-based image region tracking solution advances the state-of-the-art by introducing a new image-space UV predictor that, given an input image depicting an object, outputs UV coordinates as if those UV coordinates were projected onto the image-space from a mesh corresponding to the object depicted in the input image. Once this image-space UV map is predicted, it can advantageously be used to lookup values in a texture and create an image-space mask based on that texture.

Unlike conventional rotoscoping techniques relying on manual work and optical flow tracking, the image-space UV map-based image region tracking solution disclosed in the present application can perform flawlessly in the event of occlusions by other objects in the image, or self-occlusions such as when the depicted object is rotated between video frames. The present image-space UV map-based image region tracking solution is also much faster than conventional methods because it only requires the image region being tracked to be identified by a system user on a single video frame or texture template.

Due to the ability of the image-space UV map-based image region tracking solution disclosed herein to compensate for occlusions naturally, the need for an additional visibility prediction or occlusion computation required by conventional dense facial landmark detectors is eliminated, while retaining system user flexibility in the selection of image regions to be tracked. Moreover, the image region masks produced using the present image-space UV map-based image region tracking approach are fully defined at inference, while all conventional semantic face segmentation techniques require retraining a model for each new mask.

It is noted that in some implementations, the present image-space UV map-based image region tracking solution may advantageously be implemented as automated systems and methods. As used in the present application, the terms “automation,” “automated” and “automating” refer to systems and processes that do not require the participation of a human system operator. Thus, the methods described in the present application may be performed under the control of hardware processing components of the disclosed systems.

It is also noted that, as defined in the present application, the expression “ML model” refers to a computational model for making predictions based on patterns learned from samples of data or training data. Various learning algorithms can be used to map correlations between input data and output data. These correlations form the computational model and can be used to make future predictions on new input data. Such a predictive model may include one or more logistic regression models, Bayesian models, artificial neural networks (NNs) such as transformers, large-language models (LLMs), or multimodal foundation models, to name a few examples. In various implementations, ML models may be trained as classifiers and may be utilized to perform image processing, audio processing, natural-language processing, and other inferential analyses. A “deep neural network,” in the context of deep learning, may refer to a NN that utilizes multiple hidden layers between input and output layers, which may allow for learning based on features not explicitly defined in raw data. As used in the present application, a feature identified as a NN refers to a deep neural network.

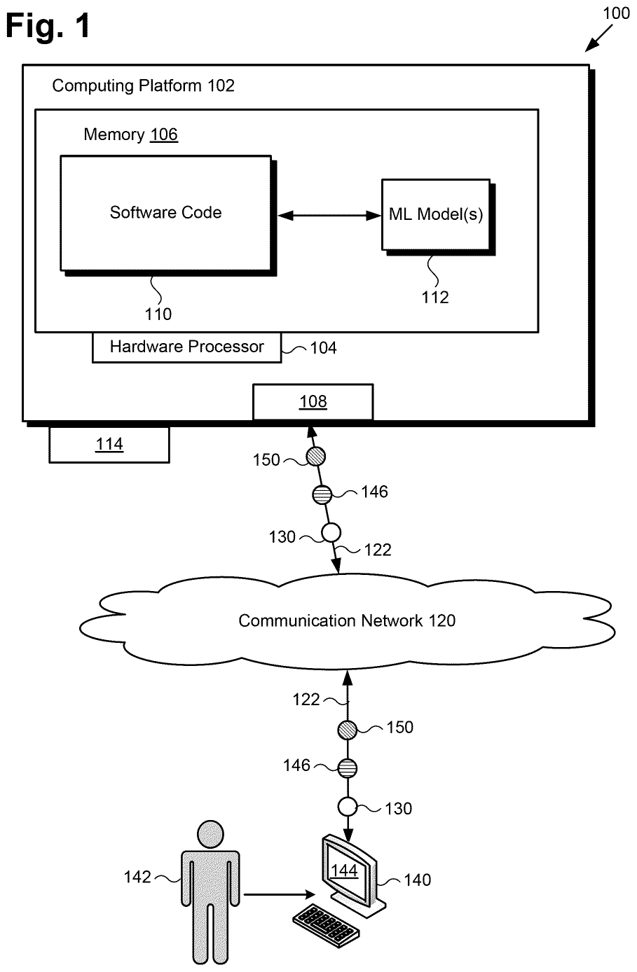

FIG. 1 shows exemplary system 100 for performing image-space UV map-based tracking of image regions in video, according to one implementation. As shown in FIG. 1, system 100 includes computing platform 102 having hardware processor 104, memory 106 implemented as a computer-readable non-transitory storage medium, transceiver 108, and in some implementations may include optional display 114. According to the present exemplary implementation, memory 106 stores software code 110 and one or more trained ML models 112 (hereinafter “trained ML model(s) 112”). In some implementations, trained ML model(s) 112 may include one or more feature extraction ML model(s) and one or more image-space UV mapping ML model(s) in the form of a transformer-based ML model or models, for example.

As further shown in FIG. 1, system 100 is implemented within a use environment including user system 140 including display 144, and communication network 120 providing network communication links 122 communicatively coupling system 100 with user system 140. Also shown in FIG. 1 is system user 142 utilizing user system 140 to interact with system 100, as well as sequence of images 130 and masking input 146 received by system 100 from user system 140, and masked sequence of images 150 corresponding to sequence of images 130 and output to user system 140 by system 100.

Although the present application refers to software code 110 and trained ML model(s) 112 as being stored in memory 106 for conceptual clarity, more generally, memory 106 may take the form of any computer-readable non-transitory storage medium. The expression “computer-readable non-transitory storage medium,” as defined in the present application, refers to any medium, excluding a carrier wave or other transitory signal, that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, internal and external hard drives, optical discs, RAM, programmable read-only memory (PROM), erasable PROM (EPROM) and FLASH memory.

Moreover, in some implementations, system 100 may utilize a decentralized secure digital ledger in addition to memory 106. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

It is further noted that although FIG. 1 depicts software code 110 and trained ML model(s) 112 as being stored together in a single instance of memory 106, that representation is merely provided as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and memory 106 may correspond to distributed processor and memory resources within system 100. Consequently, in some implementations, software code 110 and trained ML model(s) 112 may be stored remotely from one another on the distributed memory resources of system 100. It is also noted that, in some implementations, trained ML model(s) 112 may take the form of one or more software modules included in software code 110.

Hardware processor 104 may include a plurality of hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from memory 106, while a GPU may be implemented to reduce the processing overhead of the CPU by performing computationally intensive graphics or other processing tasks. A TPU is an application-specific integrated circuit (ASIC) configured specifically for artificial intelligence (AI) applications such as ML modeling.

Transceiver 108 of system 100 may be implemented as a wireless communication unit configured for use with one or more of a variety of wireless communication protocols. For example, transceiver 108 may include a fourth generation (4G) wireless transceiver and/or a 5G wireless transceiver. In addition, or alternatively, transceiver 108 may be configured for communications using one or more of Wireless Fidelity (Wi-Fi®), Worldwide Interoperability for Microwave Access (WiMAX®), Bluetooth®, Bluetooth® low energy (BLE), ZigBee®, radio-frequency identification (RFID), near-field communication (NFC), and 60 GHz wireless communications methods.

In some implementations, computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of limited distribution or private network. In addition, or alternatively, in some implementations, system 100 may utilize a local area broadcast method, such as User Datagram Protocol (UDP) or Bluetooth®, for instance. Furthermore, in some implementations, system 100 may be implemented virtually, such as in a data center. For example, in some implementations, system 100 may be implemented in software, or as virtual machines. Moreover, in some implementations, communication network 120 may be a high-speed network suitable for high performance computing (HPC), for example a 10 GigE network or an Infiniband network.

It is noted that, although user system 140 is shown as a desktop computer in FIG. 1, that representation is provided merely by way of example. In other implementations, user system 140 may take the form of any suitable mobile or stationary computing device or system that implements data processing capabilities sufficient to support a user interface, as well as connections to communication network 120, and perform the functionality ascribed to user system 140 herein. That is to say, in other implementations, user system 140 may take the form of a laptop computer, tablet computer, or smartphone, to name a few examples. Alternatively, in some implementations, user system 140 may be a “dumb terminal” peripheral device of system 100. In those implementations, user system 140 may be controlled by hardware processor 104 of computing platform 102.

It is also noted that display 144 of user system 140, as well as optional display 114 of system 100, may take the form of a liquid crystal display (LCD), a light-emitting diode (LED) display, an organic light-emitting diode (OLED) display, a quantum dot (QD) display, or any other suitable display screen that perform a physical transformation of signals to light. Furthermore, display 144 of user system 140 may be physically integrated with user system 140 or may be communicatively coupled to but physically separate from user system 140. For example, where user system 140 is implemented as a smartphone, laptop computer, or tablet computer, display 144 will typically be integrated with user system 140. By contrast, where user system 140 is implemented as a desktop computer, display 144 may take the form of a monitor separate from user system 140 in the form of a computer tower.

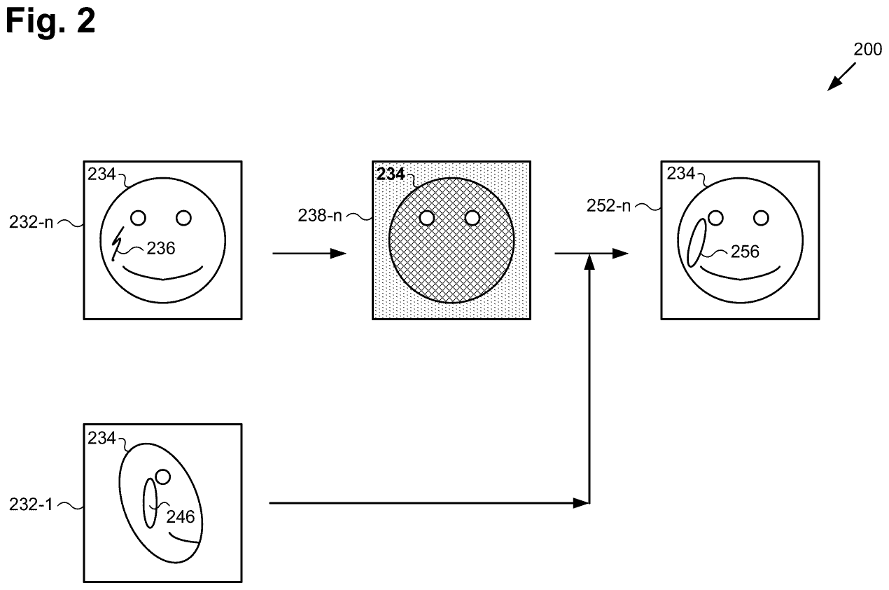

FIG. 2 shows conceptual diagram 200 depicting a process for performing image-space UV map-based tracking of image regions in video, according to one implementation. Diagram 200 includes images 232-1 and 232-n, each depicting the same object 234, shown as an exemplary human face in FIG. 2, from different perspectives. As shown in FIG. 2, object 234 includes facial scar 236. Also shown in FIG. 2 are image-space UV map 238-n of object 234 from the perspective depicted in image 232-n, masking input 246 applied to image 232-1 by a system user, such as system user 142 in FIG. 1, and masked image 252-n depicting object 234 having mask 256 obscuring facial scar 236, based on masking input 246.

It is noted that images 232-1 and 232-n correspond to individual images included among sequence of images 130, in FIG. 1, such as video frames, for example, while masked image 252-n corresponds to an image included among masked sequence of images 150 that corresponds to image 232-n of sequence of images 130. That is to say, images 232-1 and 232-n may be input video frames, and masked image 252-n may be an output video frame corresponding to input video frame 232-n but having facial scar 236 obscured by mask 256. It is further noted that although FIG. 2 shows two images 232-1 and 232-n, and one masked image 252-n, more generally images 232-1 and 232-n may correspond to any integer number of images included among sequence of images 130, while masked sequence of images 150 will typically include a masked version of each image of sequence of images 130 in which facial scar 236 of object 234 is visible. It is also noted that masking input 246 corresponds in general to masking input 146, in FIG. 1, and those corresponding features may share any characteristic attributed to either corresponding feature by the present disclosure.

Continuing to refer to FIGS. 1 and 2 in combination, trained ML model(s) 112 may be used by software code 110, executed by hardware processor 104 of system 100, to predict an image-space UV map corresponding to image-space UV map 238-n for each image included in sequence of images 130. Once those image-space UV maps are predicted, they can be used to accurately propagate or map a masked image region of an object depicted in each of sequence of images 130, based on masking input 246 applied to as few as one image, or more than one images included in sequence of images 130.

The predicted image-space UV maps are then used to invert the mapping and propagate the masked image region into texture space that can then be used for all other images of sequence of images 130. FIG. 2 shows an example of applying masking input 246 to image 232-1 so as to mask facial scar 236 on image 232-1, and then using mask 256 to track facial scar 236 on another image (i.e., image 232-n). The predicted image-space UV maps automatically handle occlusions such as the rotation of object 234 between images 232-1 and 232-n.

Alternatively, the predicted image-space UV maps can be used to lookup values in a texture and create an image-space mask based on that texture. In some use cases, the texture being used can be a pre-made texture with predetermined regions of a depicted object, such as facial regions corresponding to eye bags, cheeks, or a forehead, chin, or nose, for example. In other use cases, the texture can be painted on by a system user at runtime to create exactly the desired mask for a specific local feature of the depicted object. This texture painting task can be done in texture space using guides, for example.

It is noted that in use cases in which object 234 depicted by images 232-1 and 232-n is a human face, the present approach can be readily adapted to perform face segmentation. For example, using the predicted image-space UV maps and a texture which contains a different color for each facial area, a dense face segmentation mask can be created.

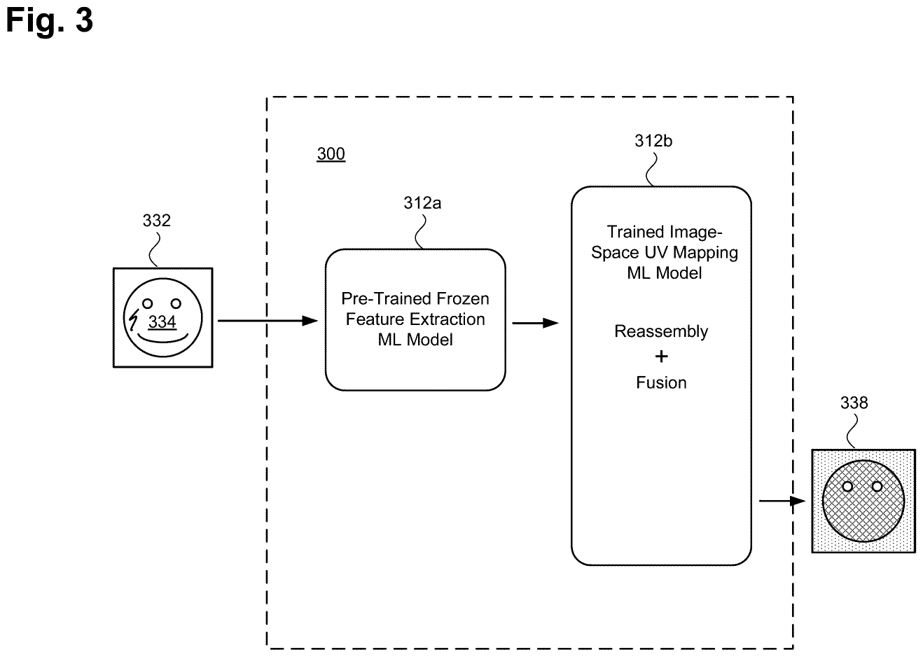

FIG. 3 shows exemplary processing pipeline 300 for predicting an image-space UV map, according to one implementation. Referring to FIGS. 1 and 3 in combination, it is noted that processing pipeline 300 may be implemented by software code 110, executed by hardware processor 104 of system 100, and using trained ML model(s) 112. It is further noted that although the processing depicted in FIG. 3 is applied to a single image 332 to predict a single image-space UV map 338, in practice each image in sequence of images 130 would undergo the processing shown in FIG. 3, resulting in a plurality of image-space UV maps each corresponding to a respective one of the images included in sequence of images 130. Thus, image 332 corresponds in general to any single image included in sequence of images 132 and image-space UV map 338 is the corresponding image-space UV mapping of that image.

As shown in FIG. 3, processing pipeline 300 receives image 332 depicting object 334, as an input. Pre-trained frozen feature extraction ML model 312a may then be used to extract visual features from image 332 and provide those extracted visual features as inputs to trained image-space UV mapping ML model 312b. Trained image-space UV mapping ML model 312b can then predict, by reassembling and fusing the visual features output by pre-trained frozen feature extraction ML model 312a for example, image space UV map 338 corresponding to object 334 depicted in image 332.

It is noted that pre-trained frozen feature extraction ML model 312a and trained image-space UV mapping ML model 312b correspond in general to trained ML model(s) 112, in FIG. 1. Consequently, trained ML model(s) 112 may share any of the characteristics attributed to either or both of pre-trained frozen feature extraction ML model 312a and trained image-space UV mapping ML model 312b, and vice versa. It is further noted that, in some implementations, trained image-space UV mapping ML model 312b may be or include a transformer-based model. In addition, image 332 depicting object 334 and image-space UM map 338 correspond respectively in general to image 232-n depicting object 234 having facial scar 236 and image-space UV map 238-n, in FIG. 2. Thus, image 332, object 334 and image-space UM map 338 may share any of the characteristics attributed to respective image 232-n, object 234 having facial scar 236 and image-space UM map 238-n by the present disclosure, and vice versa.

The prediction performed by trained image-space UV mapping ML model 312b may be formulated as an image-to-image translation task, where the input is image 332 for which image-space UV map 338 needs to be predicted, and the output is image-space UV map 338 itself. According to the exemplary implementation of processing pipeline 300 shown in FIG. 3, a pre-trained visual feature extractor is used to train image-space UV mapping ML model 312b, which may take the form of a deep NN, for example, to transform those extracted visual features into image-space UV maps. Merely by way of example, in one implementation, a pre-trained and frozen version of the DINOv2 foundational vision transformer model known in the art may be used as pre-trained frozen feature extraction ML model 312a. However, it is noted that other existing models may be substituted for the DINOv2 model. Examples of such substitute models include any vision transformer (ViT) based feature extractor, a ConvNeXt model, and the Stable Diffusion Autoencoder, to name a few.

In order to train image-space UV mapping ML model 312b, a synthetic dataset of rendered faces that contains semi-realistically rendered faces in random poses, with random accessories, hairstyle, and textures in a random environment is used. For each of the faces in this training dataset, the image-space UV map of that face is also included in the training dataset. Because all of the meshes of the training dataset share the same topology and UV parameterization, UVs can be rendered as a texture using the same camera used to create the semi-realistically rendered faces, without lighting or shading. The result is a training dataset containing a synthetic face image (render) with a corresponding image-space UV map. An L1 loss function can be used between the predicted image-space UV map and the ground truth image-space UV map.

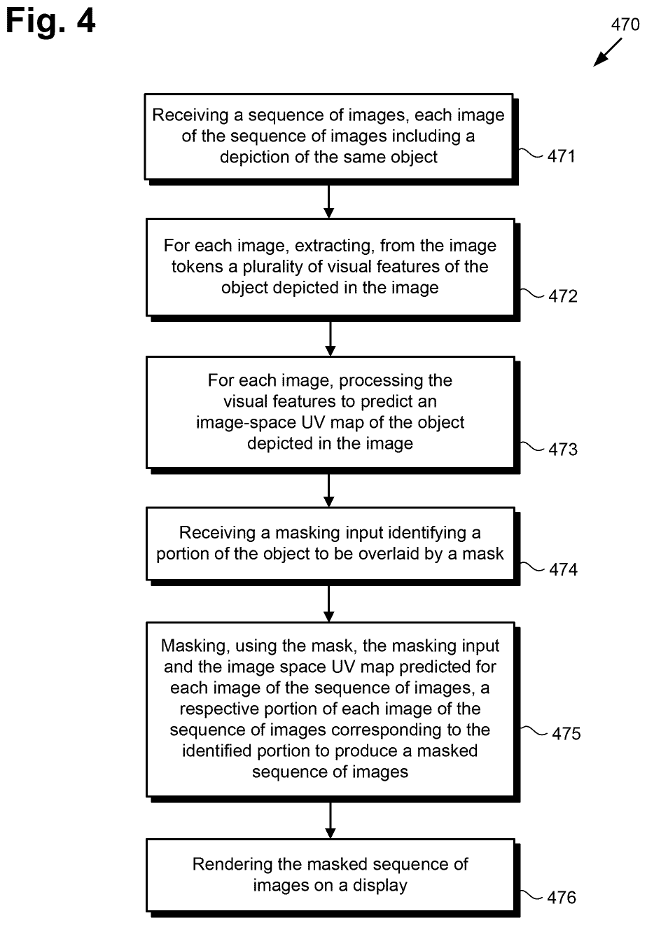

The functionality of system 100 including software code 110 and trained ML model(s) 112/312a/312b, shown in FIGS. 1 and 3, will be further described by reference to FIG. 4. FIG. 4 shows flowchart 470 presenting an exemplary method for performing image-space UV map-based tracking of image regions in video, according to one implementation. With respect to the method outlined in FIG. 4, it is noted that certain details and features have been left out of flowchart 470 in order not to obscure the discussion of the inventive features in the present application.

Referring to FIG. 4, with further reference to FIGS. 1 and 3, flowchart 470 includes receiving sequence of images 130, each image 332 of sequence of images 130 including a depiction of the same object 334 (action 471). In some use cases, object 334 depicted in each image 332 of sequence of images 130 may be a body part of a human, such as a human face for example, or an accessory worn or carried by a human, such as clothing, jewelry, or another item of personal property. In other use cases, object 334 may be a body part of an animal, or an accessory worn or attached to the animal, such as a collar, harness, leash, sweater, jacket or costume, for example. In yet other use cases, object 334 may be an animation. As noted above by reference to images 232-1 and 232-n in FIG. 2, in some use cases, object 234 may be depicted in sequence of images 130 from a plurality of different perspectives. As shown in FIG. 1, sequence of images 130 may be received from user system 140 via communication network 120 and network communication links 122, in action 471, by software code 110, executed by hardware processor 104 of system 100.

Continuing to refer to FIG. 4 in combination with FIGS. 1 and 3, flowchart 470 further includes, for each image 332 of sequence of images 130, extracting a plurality of visual features of object 334 depicted in image 332 (action 472). The extraction of visual features of object 334 from each image 332, in action 472, may be performed by software code 110, executed by hardware processor 104 of system 100, and using one or more of trained ML model(s) 112, such as pre-trained and frozen feature extraction ML model 312a, for example. As noted above, in various implementations, pre-trained and frozen feature extraction ML model 312a may take the form of a DINOv2 foundational ViT model, any other ViT based feature extractor, a ConvNeXt model, or the Stable Diffusion Autoencoder, to name a few examples.

Continuing to refer to FIG. 4 in combination with FIGS. 1 and 3, flowchart 470 further includes, for each image 332 of sequence of images 130, processing the plurality of visual features extracted in action 472 to predict image-space UV map 338 of object 334 depicted 334 in image 332 (action 473). The prediction of image-space UV map 338 of object 334, in action 473, may be performed by software code 110, executed by hardware processor 104 of system 100, and using one or more of trained ML model(s) 112, such as trained image-space UV mapping ML model 312b, for example.

As noted above, trained image-space UV mapping ML model 312b may take the form of a deep NN, and may be or include a transformer-based model, for example. As further noted above by reference to FIG. 3, processing the plurality of visual features extracted in action 472 to predict image-space UV map 338 of object 334 for each image 332 of sequence of images 130 may include reassembling and fusing the plurality of visual features extracted from each image 332 using trained image-space UV mapping ML model 312b.

Referring to FIG. 4 in combination with FIGS. 1 and 2, flowchart 470 further includes receiving masking input 146/246 identifying a portion of object 234 (e.g., exemplary facial scar 236) to be overlaid by mask 256 (action 474). As noted above by reference to FIG. 2, masking input 146/246 may be directly applied to single image 232-1 of sequence of images 130 by system user 142. Alternatively, masking input 146/246 may be applied to a texture. As further noted above, in some use cases such a texture can be a pre-made texture with predetermined regions of a depicted object, such as facial regions corresponding to eye bags, cheeks, or a forehead, chin, or nose, for example. However, in other use cases in which masking input 146/246 is applied to a texture, the texture can be painted on by a system user at runtime to create exactly the desired mask 256 for a specific local feature of depicted object 234. That texture painting task can be done in texture space using guides, for example. As shown in FIG. 1, masking input 146 may be received from user system 140 via communication network 120 and network communication links 122, in action 474, by software code 110, executed by hardware processor 104 of system 100.

Referring to FIG. 4 in combination with FIGS. 1, 2 and 3, flowchart 470 further includes, masking, using mask 256, masking input 146/246 and image-space UV map 338 predicted for each image 332 of sequence of images 130, a respective portion of each image 332 of sequence of images 130 corresponding to the portion of object 234/334 identified by masking input 146/246 (e.g., facial scar 236) to produce masked sequence of images 150 (action 475). Action 475 may be performed by software code 110, executed by hardware processor 104 of system 100.

As noted above by reference to FIG. 2, predicted image-space UV maps, such as image-space UV map 238-n predicted for image 232-n, may be used to propagate the image region to be masked by mask 256 into texture space that can be used for all other images of sequence of images 130. FIG. 2 shows an example of applying masking input 246 to image 232-1 so as to mask facial scar 236 on image 232-1, and then using mask 256 to track and mask facial scar 236 on another image (i.e., image 232-n). As further noted above, the predicted image-space UV maps can automatically handle occlusions such as the rotation of object 234 between images 232-1 and 232-n. Thus, like sequence of images 130, masked sequence of images 150 may depict object 234/334 from a plurality of different perspectives.

It is noted that although the specific use case described by reference to FIGS. 2 and 3 depict use of mask 256 to obscure facial scar 236 on object 234/334 in the form of a human face, that use case is provided merely as an example. In other use cases in which object 234/334 is a human face, the masking performed in action 475 may result in application of digital makeup, skin smoothing, de-ageing, other blemish elimination, or any combination thereof. Moreover, in use cases in which object 234/334 is an accessory worn or carried by a human, or is depicted as an animation, the masking performed in action 475 may result in changing the color of the portion of object 234/334 identified by masking input 146/246.

In some implementations, the method outlined by flowchart 470 may conclude with action 475, described above. However, and referring to FIGS. 1 and 4 in combination, in other implementations, flowchart 470 may further include rendering masked sequence of images 150 on a display (action 476). It is emphasized that action 476 is optional and, in some implementations, may be omitted from the method outlined by flowchart 470. In implementations in which action 476 is performed, the rendering of masked sequence of images 150 may be performed by software code 110, executed by hardware processor 104 of system 100. In some such implementations, masked sequence of images 150 may be rendered on optional display 114 of system 100. However, in implementations in which user system 140 is a “dumb terminal” peripheral device of system 100, masked sequence of images 150 may be rendered on display 144 of user system 140, under the control of hardware processor 104 of system 100.

With respect to the method outlined by FIG. 4, it is further emphasized that actions 471, 472, 473, 474 and 475 (hereinafter “actions 471-475”), or actions 471-475 and 476, may be performed in an automated process from which human involvement may be omitted.

Thus, the present application discloses systems and methods for performing image-space UV map-based tracking of image regions in video that address and overcome the drawbacks and deficiencies in the conventional art. The present novel and inventive image-space UV map-based image region tracking solution advantageously uses the relationship between points on a 3-D surface and their corresponding 2-D UV locations and advances the state-of-the-art by introducing a new image-space UV predictor that, given an input image depicting an object, outputs UV coordinates as if those UV coordinates were projected onto the image-space from a mesh corresponding to the object depicted in the input image. Once this image-space UV map is predicted, it can advantageously be used to lookup values in a texture and create an image-space mask based on that texture.

Unlike conventional rotoscoping techniques relying on manual work and optical flow tracking, the image-space UV map-based image region tracking solution disclosed in the present application can perform flawlessly in the event of occlusions by other objects in the image, or self-occlusions such as when the depicted object is rotated between video frames. The present image-space UV map-based image region tracking solution is also much faster than conventional methods because it only requires the image region being tracked to be identified by a system user on a single video frame or texture template.

In addition, due to the ability of the image-space UV map-based image region tracking solution disclosed herein to compensate for occlusions naturally, the need for an additional visibility prediction or occlusion computation required by conventional dense facial landmark detectors is eliminated, while retaining system user flexibility in the selection of image regions to be tracked. Moreover, the image region masks produced using the present image-space UV map-based image region tracking approach are fully defined at inference, while all conventional semantic face segmentation techniques require retraining a model for each new mask.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor; and
a memory storing a software code;
the hardware processor configured to execute the software code to:
receive a sequence of images, each image of the sequence of images including a depiction of a same object;
for each image of the sequence of images;
extract a plurality of visual features of the same object depicted in the image; and
process the plurality of visual features to predict an image-space UV map of the same object depicted in the image;
receive a masking input identifying a portion of the same object to be overlaid by a mask; and
mask, using the masking input and the image-space UV map predicted for each image of the sequence of images, a respective portion of each image of the sequence of images corresponding to the identified portion to produce a masked sequence of images.

2. The system of claim 1, further comprising a display, wherein the hardware processor is further configured to execute the software code to render the masked sequence of images on the display.

3. The system of claim 1, further comprising a pre-trained and frozen feature extraction machine learning (ML) model, wherein extracting the visual features from each image of the sequence of images is performed using the pre-trained and frozen feature extraction ML model.

4. The system of claim 1, further comprising an image-space UV mapping ML model stored in the memory, wherein predicting the image-space UV map of the object for each image of the sequence of images is performed using the image-space UV mapping ML model.

5. The system of claim 4, wherein the image-space UV mapping ML model comprises a transformer-based model.

6. The system of claim 1, wherein processing the plurality of visual features to predict the image-space UV map of the same object for each image of the sequence of images comprises reassembling and fusing the plurality of visual features.

7. The system of claim 1, wherein the sequence of images and the masked sequence of images depict the same object from a plurality of different perspectives.

8. The system of claim 1, wherein the depicted same object is: (i) a body part of a human or an animal, or (ii) an accessory worn by the human or the animal.

9. The system of claim 1, wherein the depicted same object is a human face, and wherein masking results in at least one of application of digital makeup, skin smoothing, de-aging, or blemish elimination for the human face in the masked sequence of images.

10. The system of claim 1, wherein the depicted same object is an animation.

11. A method for use by a system including a hardware processor and a memory storing a software code, the method comprising:
receiving, by the software code executed by the hardware processor, a sequence of images, each image of the sequence of images including a depiction of a same object;
for each image of the sequence of images;
extracting, by the software code executed by the hardware processor, a plurality of visual features of the same object depicted in the image; and
processing, by the software code executed by the hardware processor, the plurality of visual features to predict an image-space UV map of the same object depicted in the image;
receiving, by the software code executed by the hardware processor, a masking input identifying a portion of the same object to be overlaid by a mask; and
masking, by the software code executed by the hardware processor and using the masking input and the image-space UV map predicted for each image of the sequence of images, a respective portion of each image of the sequence of images corresponding to the identified portion to produce a masked sequence of images.

12. The method of claim 11, wherein the system further comprises a display, the method further comprising:
rendering, by the software code executed by the hardware processor, the masked sequence of images on the display.

13. The method of claim 11, further comprising a pre-trained and frozen feature extraction machine learning (ML) model, wherein extracting the visual features from each image of the sequence of images is performed using the pre-trained and frozen feature extraction ML model.

14. The method of claim 11, further comprising an image-space UV mapping ML model stored in the memory, wherein predicting the image-space UV map of the object for each image of the sequence of images is performed using the image-space UV mapping ML model.

15. The method of claim 14, wherein the image-space UV mapping ML model comprises a transformer-based model.

16. The method of claim 11, wherein processing the plurality of visual features to predict the image-space UV map of the same object for each image of the sequence of images comprises reassembling and fusing the plurality of visual features.

17. The method of claim 11, wherein the sequence of images and the masked sequence of images depict the same object from a plurality of different perspectives.

18. The method of claim 11, wherein the depicted same object is: (i) a body part of a human or an animal, or (ii) an accessory worn by the human or the animal.

19. The method of claim 11, wherein the depicted same object is a human face, and wherein masking results in at least one of application of digital makeup, skin smoothing, de-aging, or blemish elimination for the human face in the masked sequence of images.

20. The method of claim 11, wherein the depicted same object is an animation.
